(19) United States
(12) Patent Application Publication
(10) Pub. No.: US 2011/0316964 A1
(43) Pub. Date: Dec. 29, 2011

(54) WIRELESS COMMUNICATION DEVICE

(76) Inventor: Yosuke NAKANISHI, Yokohama (JP)

(21) Appl. No.: 13/171,067

(22) Filed: Jun. 28, 2011

(30) Foreign Application Priority Data
Jun. 28, 2010 (JP) 2010-145936

(51) Int. Cl. H04N 7/14

(52) U.S. Cl. 348/14.02; 348/E07.078

(57) ABSTRACT

A wireless communications device establishes effective video calls, even if the user is not aware of the appropriate imaging conditions. An image resizing system and method for a wireless communication device is disclosed. Video data is captured and modified based on an operating condition. The modified video data is then transmitted through a communication channel. In this manner, processing time and processing load of a wireless communication device are reduced, while allowing a smooth communication during video calls.

### CROSS-REFERENCE TO RELATED APPLICATION

The present application claims priority under 35 U.S.C. §119 to Japanese Patent Application No. 2010-145936, filed on Jun. 28, 2010, entitled “MOBILE WIRELESS COMMUNICATION TERMINAL DEVICE”. The content of which is incorporated by reference herein in its entirety.

### FIELD

Embodiments of the present disclosure relate generally to wireless communication devices, and more particularly relate to image processing on a wireless communication device.

### BACKGROUND

Some mobile electronic devices can take or receive images, which may be taken by a camera module comprising a charge coupled device (CCD) and the like, and convert the images into digital data (image data). The mobile electronic devices may subsequently store the image data in an internal memory, and then display the image data on a display (e.g., an LCD) or send the image data to other external devices.

Some electronic devices may have a wireless videotelephone function. Using the videotelephone function, an electronic device may transmit video data imaged by a user using a camera of the electronic device, along with voice data to a second device of an intended recipient. Substantially simultaneously, based on the data transmitted from the device of the intended recipient, the electronic device may display video data of the intended recipient on the display and output a recorded voice of the intended recipient from the speaker, in order to establish calls.

When a user makes a video call, using the video telephone function, such that an image of his/her face is placed in an appropriate position of the overall image (for example, in a center position), it is necessary to select appropriate imaging conditions (imaging angles, positions and the like) and use the electronic device (generally, used by holding it with the hands), and even during the call, it is also necessary to maintain the appropriate imaging conditions.

When using the video telephone function, because it is intended to make calls while looking at a face of the intended recipient on the display module, images other than the upper half of the body (for example, background images) are not considered necessary information.

### SUMMARY

A wireless communications device establishes effective video calls, even if the user is not aware of the appropriate imaging conditions. An image resizing system and method for a wireless communication device is disclosed. Video data is captured and modified based on an operating condition. The modified video data is then transmitted. In this manner, processing time and processing load of a wireless communication device are reduced, while allowing a smooth communication during video calls.

In an embodiment, a wireless communication device comprises: a camera module, an image processing module, and a communication module. The camera module captures video data, and the image processing module modifies the video data based on an operating condition. Further, the communication module transmits the modified video data.

In another embodiment, a method for modifying an image in a wireless communication device captures video data and modifies the video data based on an operating condition. The modified video data is then transmitted through a communication channel.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exemplary external perspective view of a mobile phone according to an embodiment of disclosure.

FIG. 2 is an illustration of an exemplary perspective view of a folded state of the mobile phone of FIG. 1.

FIG. 3 is an illustration of an exemplary function block diagram of a mobile phone according to an embodiment of disclosure.

FIG. 4 is an illustration of an exemplary flowchart showing a process for operating a control module of a mobile phone for using video calls according to an embodiment of disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, an information-processing device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, GPS's or navigation systems, pedometers, health equipments, display monitors, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

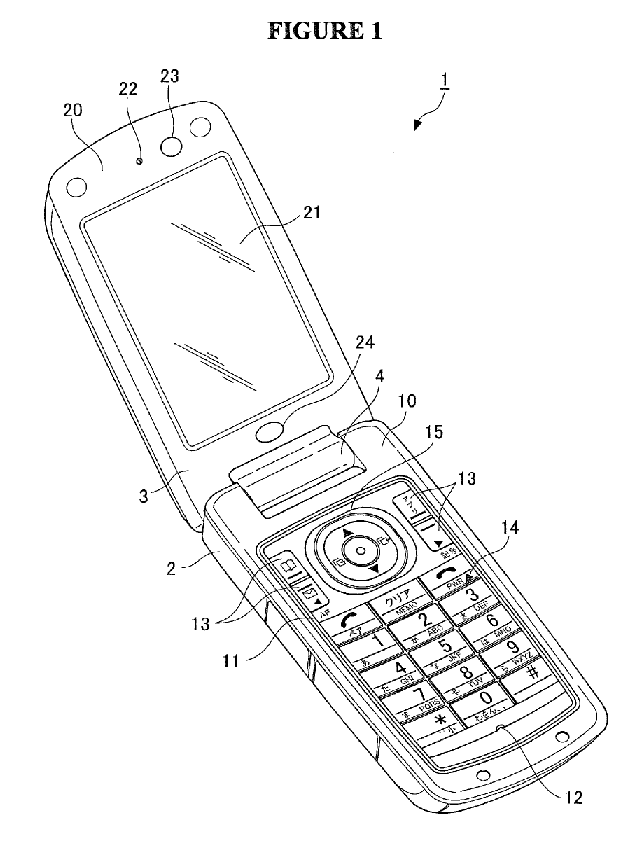

FIG. 1 is an illustration of an exemplary external perspective view of a mobile phone 1 (mobile phone 1) according to an embodiment of disclosure. The mobile phone 1 may be, for example but without limitation, a sliding type in which a first chassis and a second chassis can slide in one direction from a state where the first chassis and the second chassis are overlapped; a folding type comprising a first chassis (manipulation-side chassis), a second chassis (display-side chassis) and a coupling portion coupling the chassis; a turning type in which one of the first chassis or the second chassis is made to turn around an axis line along an overlapping direction of a first chassis and a second chassis; a straight type in which the first chassis and the second chassis are arranged in one chassis comprising no coupling portion, and the like.

In an embodiment the mobile phone 1 comprises an operation module side housing module 2, and a display module side housing module 3.

The operation module side housing module 2 comprises a display module 10, an operation module 11, and a microphone 12 which receives voice of a user of the mobile phone 1.

The operation module 11 comprises a function setting operation key 13 for operating various settings and functions, such as the address book function and the e-mail function; an input operation key 14 for inputting telephone numbers as well as characters for e-mails and the like, and a decision operation key 15 for carrying out decisions or scrolling for various operations.

The display module side housing module 3 comprises a display module 21 for displaying a variety of information on a display module 20 (e.g., a Liquid Crystal Display (LCD)), a speaker 22 for outputting the voice of the intended recipient of the calls; a camera module 23 for imaging the object; and a speaker 24.

The camera module 23 is configured to capture video data. The camera module 23 is primarily used during calls that use the television (video) telephone function. In an embodiment, video calls are made using the camera module 23 (In camera). Alternatively, video calls may be made using the camera module 31 (Out camera). In this case, the user of the mobile phone 1 may verify the facial image of the intended recipient, using other monitors.

A diameter of the speaker 24 is configured so as to be larger than the speaker 22, thus the speaker 24 can output louder sounds than the speaker 22. The speaker 24, for example, is used when outputting a voice of the intended recipient externally, for cases in which the video telephone function is used. In an embodiment, for cases of normal calls, the voice of the intended recipient is output from the speaker 22, and for cases of calls using video calls, the voice of the intended recipient is output from the speaker 24. Alternatively, if the speaker 22 is usable even in a hands-free state, for cases of normal calls, and for cases of calls using video calls, the voice of the intended recipient may be output from the speaker 22. In this case, the speaker 24 is not necessary.

An upper module of the operation module side housing module 2 and a lower module of the display module side housing module 3 are coupled via a hinge mechanism 4. By rotating the operation module side housing module 2 relative to the display module side housing module 3, the mobile phone 1 can cause the operation module side housing module 2 and the display module side housing module 3 to reach an open state relative to each other or cause the operation module side housing module 2 and the display module side housing module 3 to reach a folded state.

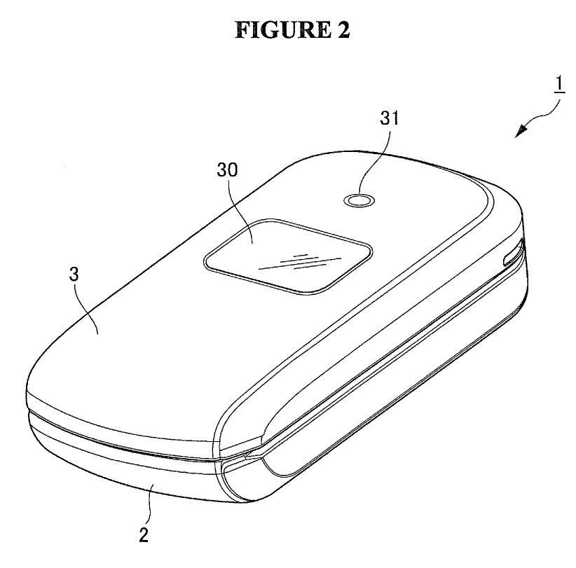

FIG. 2 is an illustration of an exemplary perspective view of a folded state of the mobile phone 1 of FIG. 1. The operation module side housing module 2 comprises, on the external planar part, a sub-display module 30 on which a clock, incoming e-mails and the like, are displayed, and a camera module 31 that images objects. This mobile phone 1 comprises, a function by which, while making a television (video) call, effective video calls can be established even if the user is not aware of the appropriate imaging conditions.

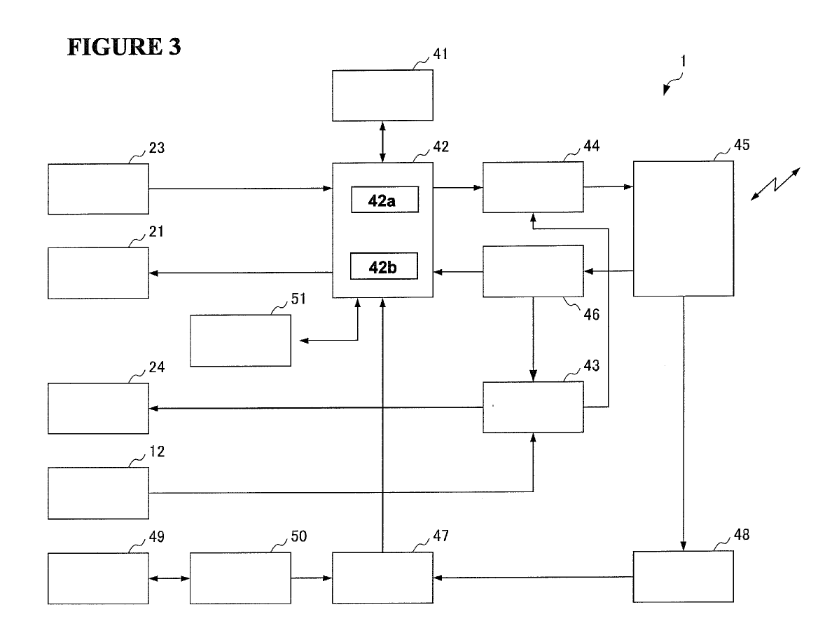

FIG. 3 is an illustration of an exemplary function block diagram of a mobile phone 1 (system 300) according to an embodiment of disclosure. The mobile phone 1 comprises: the microphone 12; the display module 21, the camera module 23, the speaker 24, a face recognition module 41, a video processing module 42, a voice processing module 43, a synthesis processing module 44, a wireless communication module 45, a separation processing module 46, a control module 47, a communication quality control module 48, a battery level control module 50, and a storage module 51.

The system 300 is operable to capture video data, and modify/resize the video data based on an operating condition of the system 300, and transmit the modified/resized video data through a communication channel as explained in more detail below.

The face recognition module 41 is configured to authenticate images. For example, the face recognition module 41 authenticates a face of a person in video images taken by the camera module 23. Authentication may comprise a predefined analytical method, for example but without limitation, a principal component analysis method based on local patterns of facial parts (eyebrows, eyes, nose, mouth, cheeks and the like), and the like. Additionally, other controls may also be performed using information of the authenticated face.

For example, the mobile phone 1 may determine a distance from a size a facial images of the authenticated face, improve the sensitivity of the microphone 12, and carry out controls so as to increase a volume of the speaker 24. The mobile phone 1 may determine a brightness of the surroundings from the brightness of the facial images that are authenticated, and may carry out controls so as to light a supplementary light (not shown in the figures).

The video processing module 42 is configured to modify/resize the video data based on an operating condition of the mobile phone 1 to provide a modified video data. The operating conditions may comprise, for example but without limitation, a battery level, a channel bandwidth, a communication speed, communication channel quality, and the like. The video processing module 42 receives the video data via video signals from the controller 47 and performs predefined video processing as explained in more detail below, and outputs the processed video data to the display module 21. The video processing module 42 may process static images, and video data comprising continuous images of still images.

The video processing module 42 comprises a data size change module 42a and a trimming function module 42b and is operable to carries out predefined processing, with respect to the video data. The video processing module 42 deletes information such as background images that is different from the authenticated face. The video processing module 42, for cases in which the person whose face is recognized (authenticated) appears in a corner of the image, carries out moving processing such that the image of the person moves to a central position of the entire image, and may carry out processing by which images other than that of the person under consideration are deleted.

The data size change module 42a is operable to trim a size of the video data to provide the modified video data. For example, the data size change module 42a changes a size of the video data that is transmitted to the intended recipient by a video communication via the wireless communication module 45. For another example, the data size change module 42a enlarges the modified video data to a predefined data size, if the modified video data is smaller than the predefined data size.

The trimming function module 42b is operable to trim the video data. The video processing module 42 outputs the video data as video signals after processing by the synthesis processing module 44. The trimming comprise, for example but without limitation, deleting of some of the video data, changing a position of a predefined image comprised in the video data (e.g., facial image of a person), changing the data size of the video data, and the like. By trimming the video data, the mobile phone 1, can transmit an appropriate video data to a receiver of a communication device of an intended recipient during video calls.

In one embodiment, the data size change module 42a defines a selected portion of the video data that is different from the authenticated face, and the trimming function module 42b removes the selected portion thereby trimming a size of the video data to provide the modified video data.

The voice processing module 43 processes (for example, digital conversion processing) voice signals received from the microphone 12, and supplies the processed voice signals to the synthesis processing module 44.

The voice processing module 43 processes (for example, analog signal processing) input voice signals received from the separation processing module 46, and sends them to the speaker 24. For cases in which voice data of the video data is output, the video data displayed on the display module 21 and the sound output from the speaker 24, are synchronized to prevent any synchronization gaps.

The speaker 24 outputs the sound externally, based on the voice signals supplied from the voice processing module 43.

The synthesis processing module 44 synthesizes the video signals input from the video processing module 42 and the voice signals input from the voice processing module 43, and outputs the signals after synthesis (synthetic signals) to the wireless communication module 45.

The wireless communication module 45 is operable to transmit and receive a plurality of communication signals comprising, for example but without limitation, data signals, modified video data, and the like. The wireless communication module 45 is operable to transmit and receive the communication signals through a communication channel such as a wireless communication channel to/from a base station. The communication module 45 communicates with the wireless network via a wireless data communication link (not shown). The communication module 45 cooperates with a base station transceiver (not shown) with a suitably configured RF antenna arrangement (not shown) that can support a particular wireless communication protocol and modulation scheme to transmit and receive the data signals form and to the control module 47.

The data signals may comprise, for example but without limitation, voice data during voice communication, image signal during video communication, text data during email, web data during accessing web site, and the like. The wireless communication protocol and modulation scheme may comprise, for example but without limitation, Code Division Multiple access (CDMA), Frequency Division Multiplex (FDM), and the like.

The wireless communication module 45 performs predefined signal processing on synthetic signals input from the synthesis processing module 44, and transmits the signals after processing to the base station. The wireless communication module 45, demodulates the signals received from the base station, and outputs the signals after processing to the separation processing module 46. The separation processing module 46 separates the signals that are input into video signals and voice signals, then outputs the video signals to the video processing module 42, and outputs the voice signals to the voice processing module 43.

The controller 47 is configured to support functions of the system 300. The controller 47 may control operations of the system 300 so that processes of the system 300 are suitably performed. For example, the controller 47 controls operations of the microphone 12, the display module 21, the camera module 23, the speaker 24, the face recognition module 41, the video processing module 42, a voice processing module 43, a synthesis processing module 44, the wireless communication module 45, the separation processing module 46, the control module 47, the communication quality control module 48, the battery level control module 50, and the storage module 51 to saves processing time and reduce processing load while allowing a smooth communication during video calls.

For example, the control module 47, controls the operation of the video processing module 42 based on the operating condition as explained in more detail below. For example, if the communication speed falls below (low bandwidth) a predefined speed, the control module 47 controls the video processing module 42 such that the video data taken by the camera module 23 is trimmed accordingly by the video processing module 42. The controller 47 also controls the display module 21 to display input/output parameters, and the like. Further, the controller 47 accesses the storage module 51 such as access to trimmed video data, still images, input data, predetermined values of communication speed, predetermined values of communication battery level, battery level, RSSI values, and the like.

In a state in which the communication speed falls below a predefined speed, when the data transmission resulting from video calls occurs, because the throughput decreases, it takes time for the transmitted data to reach the communication device of the intended recipient, making it difficult to establish smooth conversations. In order to avoid this type of situation, for cases in which the communication speed falls below the predefined speed, the mobile phone 1 decreases the data size of the video data by trimming before transmitting; thereby, allowing smooth conversations to be established. As a result, for cases in which the communication speed falls below the predefined speed at the time of making video calls, the mobile phone 1 establishes effective video calls even if the user is not aware of the appropriate imaging conditions.

The control module 47, according to the communication speed resulting from the wireless communication module 45, controls the operation of the face recognition module 41 and the video processing module 42. If the communication speed falls below the predefined speed, the face recognition module 41 performs facial recognition on a face of the person in the image taken with the camera module 23 The face recognition module 41 then causes the video processing module 42 to trim the image by which some or all of the information other than that of the person whose face is recognized or authenticated by the face recognition module 41 is removed from the image taken by the camera module 23 in the video processing module 42.

The controller 47, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like.

A processor may also be implemented as a combination of computing devices, e.g., a combination of a digital signal processor and a microprocessor, a plurality of microprocessors, one or more microprocessors in conjunction with a digital signal processor core, or any other such configuration. In practice, the controller 47 comprises processing logic that is configured to carry out the functions, techniques, and processing tasks associated with the operation of system 300. The communication quality control module 48 controls the wireless communication state of the wireless communication module 45, from communication quality based on the error rate and Received Signal Strength Indicator (RSSI).

The battery level control module 50 in configured to control a remaining battery level of a battery 49. In this manner, the battery level control module 50 controls the remaining battery level such that the face recognition module 41 performs a facial recognition on the video data during video communications to provide an authenticated face, if the remaining battery level falls below a predefined level.

The storage module 51 is configured to store the video data comprising the authenticated face/image which is authenticated by the face recognition module 41. In this manner, the storage module 51 allows the wireless communication module to read the stored authenticated image to provide a read image, discontinue trimming the video data, and transmit the read image, if the facial recognition is not possible, and restart the trimming and transmitting of the video data, if the facial recognition is possible.

The face recognition module 41 is configured to authenticate an image. For example, the face recognition module 41 authenticates a face of a person in video images taken by the camera module 23. Authentication may comprise a predefined analytical method, for example but without limitation by a principal component analysis method based on local patterns of facial parts (eyebrows, eyes, nose, mouth, cheeks and the like), and the like. The video processing module 42 deletes information such as background images that is different from the authenticated face. The video processing module 42, for cases in which the person whose face has been recognized appears in a corner of the image, carries out moving processing such that the image of the person moves to a central position of the entire image, and may carry out processing by which images other than that of the person under consideration are deleted.

In one embodiment, if communication speed falls below the predefined speed or a bandwidth of the communication channel, the non-authenticated images are trimmed providing transmission of reduced data size through the communication channel; thereby allowing smooth communication to be established through the communication channel to and from the mobile phone 1. In another embodiment, a face recognition module 41 performs facial recognition on the video data during video communications to provide an authenticated face, if the communication quality falls below a predefined value.

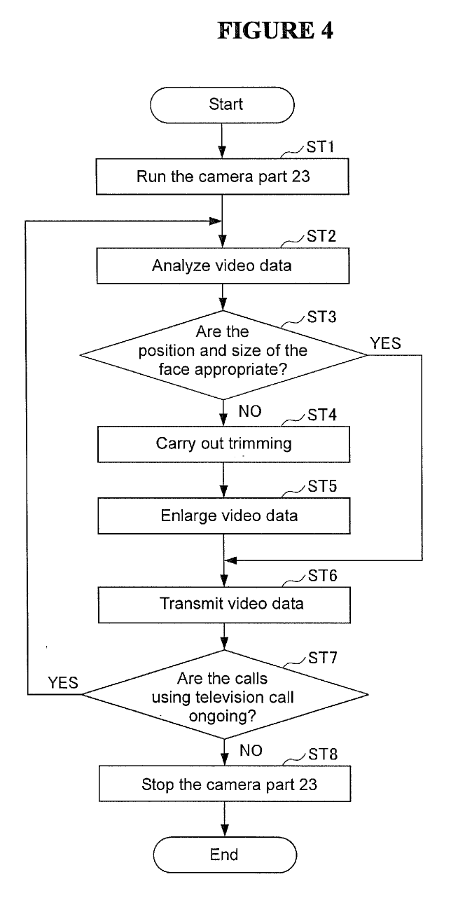

FIG. 4 is an illustration of an exemplary flowchart showing a process 400 for operating a control module of the mobile phone 1 for using video calls according to an embodiment of disclosure. The various tasks performed in connection with process 400 may be performed, by software, hardware, firmware, a computer-readable medium having computer executable instructions for performing the process method, or any combination thereof. The process 400 may be recorded in a computer-readable medium such as a semiconductor memory, a magnetic disk, an optical disk, and the like, and can be accessed and executed, for example, by a computer CPU such as the controller module 47 in which the computer-readable medium is stored.

It should be appreciated that process 400 may include any number of additional or alternative tasks, the tasks shown in FIG. 6 need not be performed in the illustrated order, and process 400 may be incorporated into a more comprehensive procedure or process having additional functionality not described in detail herein. For illustrative purposes, the following description of process 400 may refer to elements mentioned above in connection with FIGS. 1-3.

In practical embodiments, portions of the process 400 may be performed by different elements of the system 300 such as: the microphone 12, the display module 21, the camera module 23, the speaker 24, the face recognition module 41, the video processing module 42, a voice processing module 43; the synthesis processing module 44; the wireless communication module 45; the separation processing module 46, the control module 47, the communication quality control module 48, the battery level control module 50, and the storage module 51. Process 400 may have functions, material, and structures that are similar to the embodiments shown in FIGS. 1-3. Therefore common features, functions, and elements may not be redundantly described here.

For cases in which video calls are used, the sensitivity of the microphone 12 increases, and the voice of the intended recipient is output from the speaker 24, but not from the speaker 22; thereby, reaching a so-called hands-free state. In an embodiment, resulting from a predefined operation, the mobile phone 1 is communicatively coupled to a mobile phone of the intended recipient, and a condition for making video calls is assumed to be provided.

In task ST1, the control module 47 runs the camera module 23 to capture the video data.

In task ST2, the control module 47 causes the video processing module 42 to analyze the video data taken/captured by the camera module 23. The video processing module 42 causes the face recognition module 41 to carry out facial recognition processing on the video data.

In inquiry task ST3, the control module 47 determines whether or not the position and size of the face are appropriate in the video data, by facial recognition processing using the face recognition module 41. For example but without limitation, if the facial image of the person is not present in a vicinity of a central position of the video data, if the facial image of the person is small compared to the size of the entire image, and the like, the control module 47 determines that the position and size of the face are not appropriate. For cases in which it is determined that the position and size of the face are not appropriate (NO branch of inquiry task ST3), process 400 proceeds to task ST4, and for cases in which it is determined that the position and size of the face are appropriate (Yes branch of inquiry task ST3), process 400 proceeds to task ST6.

In task ST4, the control module 47 causes the video processing module 42 to carry out trimming processing. The video processing module 42 performs a trimming processing on the video data based on the results of facial recognition processing to obtain trimmed video data. The Video data may be modified based on an operating condition to provide a modified video data.

For example, when moving from above ground to underground and when a communication link between the base station and the mobile phone 1 becomes unstable, the communication quality of the mobile phone 1 falls below the predefined quality, and the throughput decreases.

When the communication quality falls below the predefined quality, process 400 defines a selected portion of the video data that is different from the authenticated face, and removes the selected portion, thereby trimming a size of the video data, In this manner, based on the result of facial recognition, by trimming the information other than that of the person under consideration (image sections), the mobile phone 1 reduces the size of the data to be transmitted; thereby, allowing smooth communication to be established.

The mobile phone 1 may have a configuration, in which, based on changes in the communication quality that are determined by the communication quality control module 48, the video processing module 42 is controlled so as to gradually increase the trimming size. The mobile phone 1 may control the video processing module 42 so as to gradually decrease an aspect ratio of the video itself, based on changes in the communication quality that are determined by the communication quality control module 48.

For another example, when it is determined by the battery level control module 50 that the remaining battery level of the battery 49 has fallen below a predefined level, the control module 47 carries out facial recognition with respect to the person contained in the video data that is imaged by the camera module 23, using the face recognition module 41, then carries out processing by which some or all of the information other than that of the person whose face is recognized by the face recognition module 41 is trimmed from the video data by the video processing module 42, and controls so as to transmit the video data that is processed by the video processing module 42, using the wireless communication module 45.

In this way, when the remaining battery level of the battery 49 falls below the predefined level the mobile phone 1 reduces the size of the data to be transmitted; thereby, allowing smooth communication to be established. In this manner, based on the result of facial recognition, the video data is trimmed. In this manner, the information other than that of a person under consideration (authenticated face), is deleted from the video data.

The mobile phone 1 may change a size of the video data based on a change in the remaining battery level of the battery 49. In this manner, the battery level control module 50 determines the battery level, and the mobile phone 1 controls the video processing module 42, such that the trimming size is gradually increased. Further, the mobile phone 1 controls the video processing module 42, such that the aspect ratio of the video itself is gradually decreased.

In task ST5, the control module 47, causes the video processing module 42 to enlarge the trimmed video data. In this manner, if the person is smaller than the predefined size in the trimmed video data, the video processing module 42 enlarges the trimmed video data to a fixed size and the like.

For the multiple people's image 1, the facial image of the user is previously registered, and the video processing module 42 performs appropriate image processing such that the facial image matching the facial image registered is enlarged.

However, there are cases in which, due to the field angle, image processing according to the desired pattern is not obtained. Therefore, selection of the patterns is loosely related to the transmission images, and for cases in which the control module 47 determines that it is not appropriate, the selected pattern may be ignored. The control module 47, for example, even for cases in which entire body image processing is selected, when the entire body cannot be imaged because the distance is too close, rather than carrying out image processing of the entire body, for example, enlargement image processing or upper body image processing are carried out instead. For cases in which multiple image processing 1 to 4 are selected, when the speaker or participants cannot make an accurate determination, rather than carrying out multiple person image processing 1 to 4, the control module 47 transmits the images without making changes, or carries out other processing.

In task ST6, the control module 47 causes the wireless communication module 45 to carry out transmission processing of the video data. In this manner, the video signals that are based on the video data and the voice signals that are input from the voice processing module 43 are processed ad synthesized by the synthesis processing module 44, and the control module 47 causes the wireless communication module 45 to transmit the synthesized signals (e.g., transmitting modified video data through a communication channel).

During video communications, if it is determined by the communication quality control module 48 that communication quality has fallen below the predefined quality, the control module 47 perform authentication by the face recognition module 41, on the person whose image is taken by the camera module 23. Then video processing module 42 trims, from the video data, some or all of the information that is different (none authenticated information) from the authenticated face, and controls video data transmission such that the trimmed video data is transmitted via the wireless communication module 45.

In inquiry task ST7, the control module 47 determines whether or not calls using video call are ongoing. If it is determined that calls using television call are ongoing (YES branch of inquiry task ST7), process 400 leads back to task ST2, and if it is determined that calls using television call are not ongoing, that is, if it is determined that the calls have ended (NO branch of inquiry task ST7), process 400 proceeds to the task ST8.

In task ST8, the control module 47 stops the camera module 23, and process 400 ends.

For the tasks from ST3 to ST5, in order to effectively establish video calls, the control module 47 may select one pattern among a plurality of appropriate image processing patterns, based on the details of the images, and following the pattern, control module 47 may cause the video processing module 42 to perform image processing. The video processing module 42 may carry out image processing, following the image processing pattern selected by the user or the intended recipient.

Image processing patterns comprises, for example but without limitation, image processing that enlarges the face (enlargement) (enlargement image processing), image processing that enlarges the upper half of the body (enlargement of the upper half of the body) (upper body image processing), image processing by which, for cases in which the user steps away from the camera module 23 by a fixed distance, the entire body of the user fits into one image (entire body image processing), image processing by which, for cases in which multiple persons are present inside the image, the face of the owner of the mobile phone 1 is enlarged (multiple persons image processing 1), and the like.

Further, image processing patterns comprises, for example but without limitation, image processing by which, for cases in which multiple persons are present inside the image, the face of the speaker is enlarged (multiple persons image processing 2), image processing by which, for cases in which multiple persons are present inside the image, all the members fit into one image (multiple persons image processing 3), image processing by which, for cases in which multiple persons are present inside the image, enlarged images of all the members are shown sequentially (multiple persons image processing 4), and the like.

In some cases video/face authentication using the face recognition module 41 is not possible. In such cases, the control module 47 discontinues trimming processing with the video processing module 42, reads an immediate image that is stored in the storage module 51, transmits the read image via the wireless communication module 45. When video/face authentication using the face recognition module 41 is possible again, the control module 47 restarts the trimming processing and transmission of the video data.

For example, when the user leaves a field angle of the camera module 23 while making video calls, for example, the mobile phone 1 may not perform video/face authentication; therefore, mobile phone 1 temporarily discontinues the trimming processing, and transmits the facial image of the user that was transmitted immediately prior. Then, when the user reenters the field angle of the camera module 23, the mobile phone 1 restarts trimming processing and continues transmission of the video data. In this manner, the mobile phone 1, allows a smooth communication to be established.

In this manner, the mobile phone 1 saves processing time and reduces processing load while allowing a smooth communication. The control module 47 may have a configuration in which trimming is performed on the video data taken by the camera module 23 and comprises extra information other than that of the authenticated face. In this case, the extra information is trimmed. If after the trimming the video data is smaller than a predefined data size, the trimmed video data is enlarged to the predefined data size.

Therefore, when making video calls, for cases in which trimming processing is carried out on the video data and for cases in which the data size becomes smaller than the predefined data size, the mobile phone 1 enlarges the image data to the predefined data size after the trimming processing; thereby, allowing smooth communication to be established.

As mentioned above, video images/data taken by the camera module 23 can be trimmed using the video processing module 42; however, according to controls from the control module 47, the images of persons/object may be enlarged using a telescopic function of the camera module 23.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A wireless communication device comprising:
a camera module operable to capture video data;
a video processing module operable to modify the video data based on an operating condition to provide modified video data; and
a wireless communication module operable to transmit the modified video data.

2. The wireless communication device according to claim 1, wherein the operating condition comprises at least one member selected from the group consisting of: a battery level, a channel bandwidth, a communication speed, and a communication quality.

3. The wireless communication device according to claim 1, further comprising a data size change module operable to trim a size of the video data to provide the modified video data.

4. The wireless communication device according to claim 1, further comprising a communication quality control module operable to control a state of the wireless communication module using a communication quality based on an error rate and a Received Signal Strength Indicator.

5. The wireless communication device according to claim 4, further comprising a face recognition module operable to perform facial recognition on the video data during video communications to provide an authenticated face, if the communication quality falls below a predefined value.

6. The wireless communication device according to claim 1, further comprising:
a data size change module operable to define a selected portion of the video data that is different from an authenticated face; and
a trimming function module operable to remove the selected portion thereby trimming a size of the video data to provide the modified video data.

7. The wireless communication device according to claim 6, wherein the data size change module is further operable to enlarge the modified video data to a predefined data size, if the modified video data is smaller than the predefined data size.

8. The wireless communication device according to claim 1, further comprising:
a battery level control module operable to control remaining battery level; and
a face recognition module operable to perform a facial recognition on the video data during video communications to provide an authenticated face, if the remaining battery level falls below a predefined level.

9. The wireless communication device according to claim 8, further comprising a storage module operable to store a stored authenticated image.

10. The wireless communication device according to claim 9, wherein the wireless communication module is further operable to:
read the stored authenticated image to provide a read image, discontinue trimming the video data, and transmit the read image, if the facial recognition is not possible; and
restart the trimming and transmitting of the video data, if the facial recognition is possible.

11. An image modification method for a wireless communication device:
capturing video data;
modifying the video data based on an operating condition to provide a modified video data; and
transmitting the modified video data through a communication channel.

12. The image modification method according to claim 11, wherein the operating condition comprises at least one member selected from the group consisting of: a battery level, a channel bandwidth, a communication speed, and a communication quality.

13. The image modification method according to claim 11, further comprising trimming a size of the video data to provide the modified video data.

14. The image modification method according to claim 11, further comprising controlling a state of a wireless communication module using a communication quality based on an error rate and a Received Signal Strength Indicator.

15. The image modification method according to claim 14, further comprising performing facial recognition on the video data during video communications to provide an authenticated face, if the communication quality falls below a predefined value.

16. The image modification method according to claim 11, further comprising:
defining a selected portion of the video data that is different from an authenticated face; and
removing the selected portion thereby trimming a size of the video data to provide the modified video data.

17. The image modification method according to claim 16, further comprising enlarging the modified video data to a predefined data size, if the modified video data is smaller than the predefined data size.

18. The image modification method according to claim 11, further comprising:
controlling remaining battery level; and
performing facial recognition on the video data during video communications to provide an authenticated face, if the remaining battery level falls below a predefined level.

19. The image modification method according to claim 18, further comprising storing a stored authenticated image.

20. The image modification method according to claim 19, further comprising:
reading the stored authenticated image to provide a read image, discontinue trimming the video data, and transmit the read image, if the facial recognition is not possible; and
restarting the trimming and transmitting of the video data, if the facial recognition is possible.
